(19) United States
(12) Patent Application Publication
(10) Pub. No.: US 2008/0167995 A1
(43) Pub. Date: Jul. 10, 2008

(54) Method for purchasing and editing ringtones

(76) Inventors: Eddy Cue, Los Altos, CA (US); Heller David, Los Altos, CA (US); Steve Jobs, Palo Alto, CA (US); Jeffrey L. Robbin, Los Altos, CA (US); Wasko Timothy, High River (CA)

Correspondence Address: TECHNOLOGY & INNOVATION LAW GROUP, PC, ATTN: 101, 19200 STEVENS CREEK BLVD., SUITE 240, CUPERTINO, CA, 95014, US

(21) Appl. No.: 11/650,858

(22) Filed: Jan. 7, 2007

(51) Int. Cl. G06Q 30/00; G06F 21/00

(52) U.S. Cl. 705/59; 705/27

(57) ABSTRACT

Techniques for purchasing, editing, and organizing ringtones are disclosed. These techniques involve, for instance, browsing a group of media assets, selecting a media asset from the group of media assets, choosing a segment of the media asset to be used as a ringtone, previewing the ringtone, purchasing the ringtone, and transferring the ringtone to a telephone. Further, these techniques involve using a host computer to synch ringtones to a telephone.

### BACKGROUND OF THE INVENTION

1. Field of the Invention

In general, the invention relates to media management applications, and, more particularly, to using a media management application to purchase telephone ringtones.

2. Description of the Related Art

In recent years there has been a proliferation of “MP3 enabled” (e.g., capable of playing audio files) cellular phones (‘cell phones’). Typically, these cell phones are capable of playing audio files as a substitute for a traditional telephone ringer (i.e., the sound a telephone makes to alert a user that he is receiving a telephone call). These call notification sounds are typically referred to as ‘ringtones’. Some cell phone ringtones come bundled with a cell phone, but these ringtones are typically low quality. Currently, it is common practice to purchase upgraded ringtones to personalize a cell phone according to a user's tastes.

Current methods of purchasing and distributing ringtones leave much to be desired. Most often, the purchase of ringtones has been performed using cellular phone web browsers and the distribution of purchased ringtones has been limited to file transfers across cellular networks. Thus there is a demand for more options for purchase and download of ringtones.

Further, while many modern cell phones can play audio files, users have been limited when picking which segment of an audio file to play as a ringtone. Most often, a purchased ringtone will include a pre-selected segment of a particular audio file, without any input from the purchaser. Moreover, on phones that allow a user to play any audio file as a ringtone, selecting an audio file as a ringtone often causes the telephone to play the first part of that audio file. From an aesthetic point of view, conventional ringtones may not contain the most desirable portion of the audio file. Thus, there is a need for greater flexibility in choosing which segment of an audio file will be played as a ringtone on a portable telephone.

Even further, while unprotected audio files may be edited using commonly available sound editing software, allowing users to create their own ringtones from audio files, audio files which have been encoded with a Digital Rights Management (DRM) scheme are typically uneditable, making them unsuitable for such use. Thus, there is a need for ways to obtain ringtones associated with DRM-encoded audio files.

In recent years music delivery or distribution over the Internet has become popular. Due to the advances in efficient file formats, such as MP3 and MPEG4, the size of media files has become small enough to make their download via the Internet practical. Also, technological advances have led to higher-speed Internet connections and lower cost of memory. The combination of these advances make downloading media files, such as for music and videos, manageable and not too time consuming.

One popular approach to online music distribution is Apple Computer's iTunes® online music store. Consumers may use the iTunes® online music store to purchase music either as individual music tracks or in albums of songs. Other music stores have also been employed to purchase music online. However, users who purchase music at an online music store do not typically gain a license to create ringtones with that music. A user who wants a ringtone typically must purchase the ringtone separately from a different vendor, since online music stores do not sell ringtones. Thus, in addition to the above concerns, there is need or making ringtones available in online music stores.

Accordingly, conventional approaches to the purchase of telephone ringtones are limited, which is a disservice to all parties involved. Thus, there is a need for improved approaches to the purchase and distribution of ringtones.

### SUMMARY OF THE INVENTION

The invention pertains to techniques for creating and purchasing ringtones for use in electronic devices, such as mobile phones (e.g., cellular phones) or other telephone-enabled devices. These techniques use a media management application and/or an online media store to browse, create, edit, purchase, and/or download ringtones for use in mobile phones. Further, these techniques can be used to manage ringtones on one or more devices, including personal computers, cellular phones, and PDAs. The invention can be implemented in numerous ways, including as a method, system, device, apparatus, graphical user interface, or computer readable medium. Several embodiments of the invention are discussed below.

In one embodiment of the invention, a ringtone is obtained by selecting a media asset, determining whether the rights to create a ringtone from the media asset has been obtained, creating the ringtone from the selected media asset, and transferring the ringtone to a mobile device (e.g., mobile telephone).

In another embodiment of the invention, a ringtone may be created from a selected portion of a media asset, whereby a user can select start and end points in the media asset for use in creating the ringtone. Further, the ringtone may be previewed before creation.

In another embodiment of the invention, a created ringtone is transferred by using a synchronization process with a host computer, for example by a USB, Firewire® (IE-1394), infrared, or wireless connection.

In another embodiment of the invention, a created ringtone is encoded using a Digital Rights Management (DRM) copy protection scheme.

In still another embodiment of the invention, a ringtone can be created by browsing a group of media assets, selecting a media asset from the group of media assets, selecting a segment of the media asset to be used as a ringtone, previewing the ringtone, purchasing the ringtone, and transferring the ringtone to a telephone.

In yet still another embodiment of the invention, a computer readable medium can include at least computer program code for creating a ringtone. The computer readable medium can include at least computer program code for selecting a media asset, computer program code for creating the ringtone from the selected media asset, and computer program code for electronically transferring the ringtone to an electronic device.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a ringtone purchase system according to one embodiment of the invention.

FIG. 2 is a flow diagram of a ringtone creation process according to one embodiment of the invention.

FIG. 3 is a flow diagram of a ringtone purchase process according to one embodiment of the invention.

FIG. 4 is a flow diagram of a ringtone editing process according to one embodiment of the invention.

FIG. 5 is a block diagram of an exemplary media asset bundle according to one embodiment of the invention.

FIG. 6 is an illustration of a graphical waveform representation of an audio file according to one embodiment of the invention.

FIGS. 7A and 7B are screenshots of exemplary iTunes® windows showing an interface for selecting, creating, and purchasing ringtones according to one embodiment of the invention.

FIG. 8 shows an exemplary computer system suitable for use with the invention.

### DETAILED DESCRIPTION OF THE INVENTION

The invention pertains to techniques for obtaining ringtones for electronic devices, such as mobile telephones. More specifically, the invention pertains to techniques for purchasing ringtones that are associated with media assets such as music files (e.g., MP3 or AAC files) or video files (e.g., television shows or movies).

The invention pertains to techniques for creating and purchasing ringtones for use in mobiles phones (e.g., cellular phones) or other telephone-enabled devices. These techniques use a media management application and/or an online media store to browse, create, edit, purchase, and/or download ringtones for use in mobile phones, typically cellular telephones (‘cell phones’). Further, these techniques can be used to manage ringtones on one or more devices, including personal computers, cellular phones, and PDAs. While the term ‘ringtone’ generally applies to audio cues indicating to a cell phone user that a call is being received at that user's cell phone, it can also apply to the sound a caller hears while a cell phone is ringing (e.g., ‘caller tones’). Further still, there is no reason why the term ‘ringtone’ should be limited for use in cell phones. Thus, a ringtone could be purchased for use as an alert sound for a variety of different devices, from personal computer alarm sounds and PDA alarm sounds to conventional telephones. Also, the invention is intended to cover video ringtones (e.g., video segments for use on video enabled devices) as well as audio ringtones.

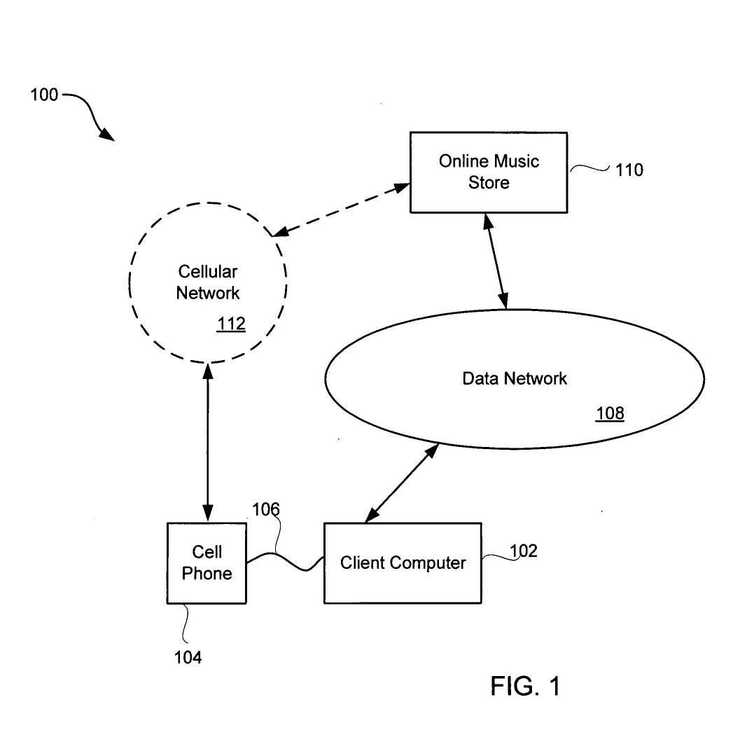

FIG. 1 is a block diagram of a ringtone purchase system 100 according to one embodiment of the invention. The ringtone purchase system 100 includes a client computer 102. The client computer 102 is, for example, a computing device, such as a personal computer. The client computer 102 can also be referred to as a host device. A cell phone 104 can be connected (e.g., temporarily connected) to the client computer 102. In one implementation, the cell phone 104 (or other telephone-enabled device) can be connected to the client computer 102 over a cable 106. As an example, the cable 106 can pertain to a peripheral bus such as a USB or Firewire® (IEEE-1394) connection. In another implementation, the cell phone 104 can connect to the client computer 102 over a wireless connection (e.g. infrared, Bluetooth®, WiFi, or WiMax). Although FIG. 1 illustrates one client computer 102 and one cell phone 104, it should be noted that the ringtone purchase system can have multiple client computers 102 and multiple cell phones 104. In addition, one or more cell phones 104 can connect to one or more client computers 102.

The ringtone purchase system 100 also illustrates a data network 108. The data network 108 is, for example, a local area network (LAN), a wide area network (WAN), or a global network, such as the Internet. In one implementation of the invention, the data network 108 includes both wired and wireless portions. The client computer 102 can couple to the data network 108. In addition, the ringtone purchase system 100 includes an online music store 110. One example of an online music store is the iTunes® online music store. A user can interact with the client computer 102 to access the online music store 110 across the data network 108 to purchase media assets, including ringtones from the online media store 110. Therefore, the transfer purchased media assets can be transferred to the cell phone 104 using the cable 106 (or wireless connection).

The ringtone purchase system 100 also illustrates a cellular network 112. The cellular network 112 is, for example, a cellular telephone network (or a combination of many cellular telephone networks). In addition to connection to the client computer 102, the cell phone 104 can connect to the cellular network 112. The cellular network 112 is capable of transferring data as well as voice (as is typical of most modern cellular networks). According to one implementation of the invention, a user may use a cell phone 104 to interact with the online music store 110 across the cellular network 112. According to another implementation of the invention, a user can use a client computer 102 to interact with an online music store 110 across a data network 108. In any case, a user can interact with the online music store 110 in order to make a purchase. The purchase can then delivered to the cell phone 104 across the cellular network 112 or via the data network 108 and the client computer 102.

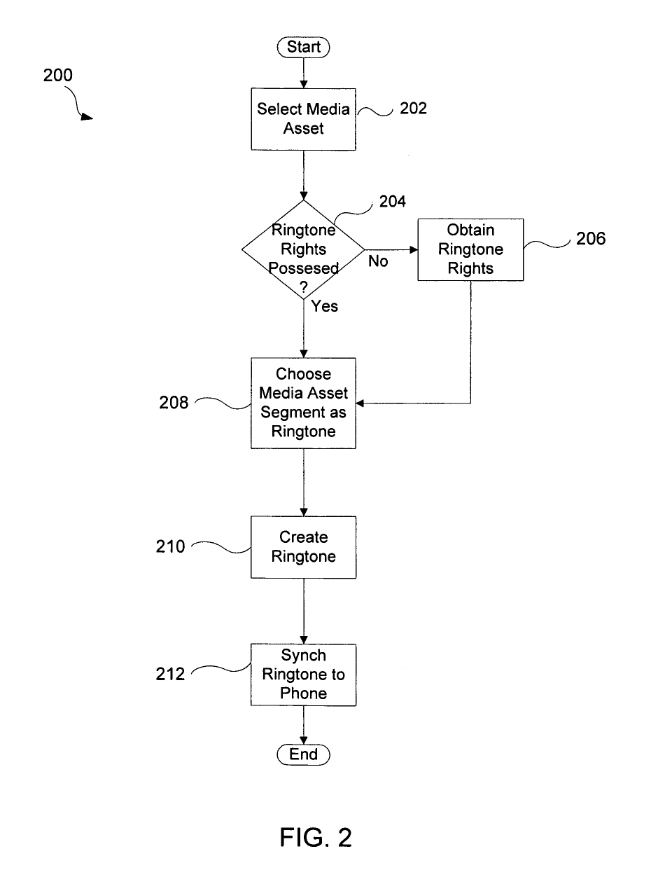

FIG. 2 is a flow diagram of a ringtone creation process 200 according to one embodiment of the invention. The ringtone creation process 200 is performed, for example, using a media management application. One example of a music management program is iTunes®, produced by Apple Computer, Inc. of Cupertino, Calif. Further, the ringtone creation process 200 can be used with the ringtone purchase system 100, described above in reference to FIG. 1.

The ringtone creation process 200 begins by selecting 202 a media asset, for example, by interacting with a media management application running on a personal computer. The selected media asset may reside locally or on a remote server, such as an online music store accessible via a computer network. One example of an online music store is the iTunes® online music store. Next, a decision 204 determines if rights (i.e., license or permission) to create a ringtone have been obtained. Various scenarios can occur with regard to the rights to create a ringtone. For example, the rights may have been purchased previously and not exercised or exercised previously but not limited to a single exercise of the rights (i.e., the license allows for the creation of more than one ringtone). Alternately, the rights may need to be purchased or otherwise acquired before continuing. In some scenarios, such as in the case of media assets in the public domain, the rights may be granted automatically without the purchase of additional rights. Next, if the ringtone rights have not already been obtained, the right to create a ringtone is obtained 206. For example, a user may interact with a media management application to purchase the rights or interact with a database to determine that no rights are necessary.

If decision 204 determines that the rights to create a ringtone are possessed, or upon obtaining 206 the rights to create a ringtone, a segment of the selected media asset is chosen 208 for use as a ringtone. The segment may be, for example, any ten-second segment of the media asset. Of course, other length segments can be used. In some embodiments, the user may only select a segment within a pre-selected portion of the selected media asset. Marketing, media piracy concerns, and aesthetics, as well as other considerations may be taken into account when allowing a user to select 208 the segment to be used in creating the ringtone. Alternately, the selection of non-contiguous segments may be allowed. One other option (not shown) would be to allow a user to “remix” the ringtone (i.e., creatively modify the ringtone like dance club DJs often do) by altering the arrangement, sequence, or other parts of the selected media asset before selecting the segment to be used as a ringtone. In some embodiments of the invention, a media asset segment is pre-selected. The pre-selected (or ‘default’) media asset segment can be determined, for example, by the artist who recorded the media asset, the record label, marketing personnel, or randomly.

Next, the ringtone is created 210 from the selected segment. The creation may simply involve copying the selected media asset segment out of the selected media asset and creating a new file that contains the media asset segment, or can include one or more intermediate transformations, such as converting the selected media asset segment (e.g., converting an MP3 to an AAC file), making volume or pitch adjustments, or file compression (e.g., making the file smaller.) Additionally, the ringtone may be encrypted using a DRM scheme such as Apple Computer's Fairplay® DRM technology. Note that DRM protection can be added regardless of whether the source media asset contained DRM protection. For example, say a user chooses 208 a media asset that is an unprotected MP3 file in that user's collection. According to some embodiments of the invention, the ringtone created 210 from that unprotected file can be encrypted using a DRM scheme. In this way, artists or music labels gain separate control over the right to create ringtones from previously purchased music.

Once the ringtone has been created 210, the ringtone can be ‘synched’ 212 (i.e., transferred via a synchronization process between two devices) to a cell phone, for example using a connection to a personal computer to a cellular phone. Any number of commonly used synchronization types may be used including, but not limited to, using a cable interface between a PC and a phone (e.g., USB or Firewire® (IEEE-1394)) or by using a wireless connection between a PC and phone (e.g. infrared, Bluetooth®, WiFi, WiMax, etc.) Alternately, a cellular network may be used to download the ringtone directly to the phone via a data connection (not shown). Further, the synching operation 212 can be used for synching 212 multiple ringtones as well as for a single ringtone.

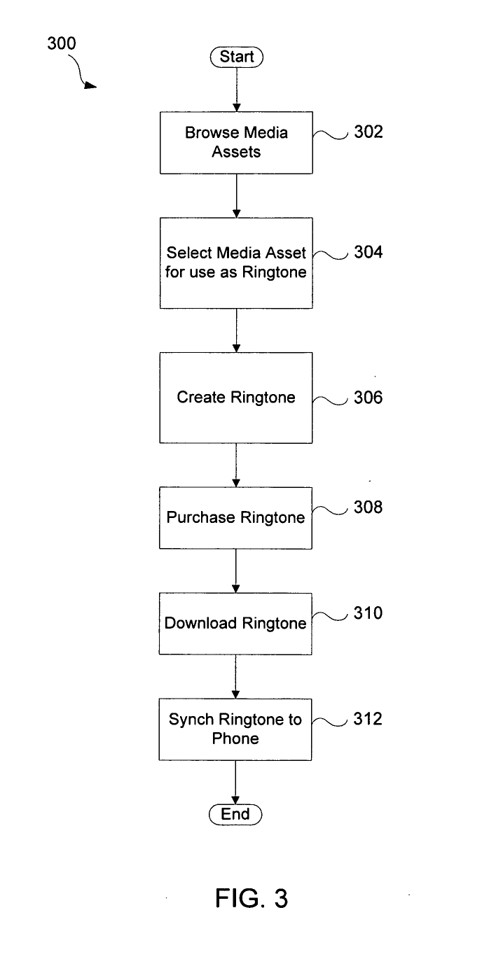

FIG. 3 is a flow diagram of a ringtone purchase process 300 according to one embodiment of the invention. The ringtone purchase process 300 is performed, for example, using a media management application to interact with an online media store. One example of a music management program is iTunes®, produced by Apple Computer, Inc. of Cupertino, Calif. One example of an online music store is the iTunes® online music store.

The ringtone purchase process 300 begins by browsing 302 media assets in an online media store. Once a desired media asset has been found, that media asset is selected 304 by the user. Next, the ringtone is created 306 using the selected media asset. The creating 306 can, for example, include choosing 208 of a media asset segment as described above in reference to FIG. 2 above. Next, the ringtone is purchased 308, for example, by interacting with an online media store to enter payment information such as credit card information. In some embodiments of the invention, the purchase 308 of the ringtone may be included in the purchase of a media asset bundle. For example, a media asset bundle can include one or more music files, a video file, and a ringtone. After the ringtone is purchased, the purchased ringtone is downloaded 310 to the user's computer. Finally, the ringtone is transferred to a cell phone via. a synching operation 312. The synching operation can be similar to the synching operation 212 as described above in reference to FIG. 2.

In some embodiments of the invention, the purchased ringtone can be downloaded directly to the device that will use the ringtone, for instance, to a cell phone, eliminating the need for the synching operation 312. In these embodiments, the purchase of the ringtone can also occur at the cell phone, with the charge going directly to the cell phone provider who, in turn, may bill the user directly. In this manner, a cell phone provider account can be used in lieu of a user account on an online music store.

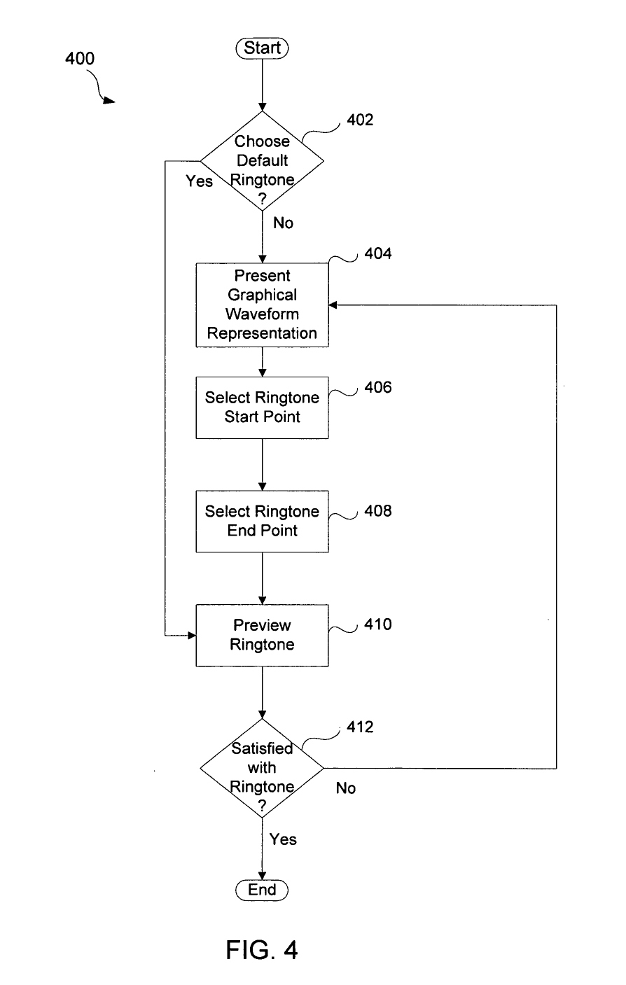

FIG. 4 is a flow diagram of a ringtone editing process 400 according to one embodiment of the invention. The ringtone editing process can occur, for example, along with the choosing 208 of a media asset segment or during the creation 306 of a ringtone, described in reference to FIGS. 2 and 3, respectively.

The ringtone editing process 400 begins with decision 402, which gives the user the option to choose a default ringtone, thus allowing the user to avoid having to edit the ringtone himself. The default media asset segment is pre-selected for the user and can be determined, for example, by the artist who recorded the media asset, the record label, marketing personnel, or randomly. Choosing the default ringtone 402 may be desirable for users who feel they lack the time or talent to create a better ringtone on their own. If the user elects this option, then decision 402 directs the ringtone editing process 400 to block 410 and subsequent blocks. If decision 402 determines that the user has not elected to take the default ringtone, then a graphical waveform representation of some or all of the media asset can be presented 404 to the user. The graphical waveform presentation typically shows the user a visual representation of the sounds contained in an audio file, much as they would appear when measured by a conventional signal generator connected to a microphone. Next, the user selects a media asset segment by selecting 406 the start of the ringtone and by selecting 408 the end of the ringtone. Once selections 406 and 408 have been made, the user can previews 410 the selection they have made for the ringtone (i.e., the proposed ringtone). Next, a decision 412 determines if the user is satisfied with the selected ringtone segment. If the decision 412 determines that the user is not satisfied with the selected ringtone segment as illustrated by the preview 410, the ringtone editing process 400 returns to block 404 and subsequent blocks. If, on the other hand, if the decision 412 determines that the user is satisfied with the ringtone as previewed 410, the ringtone editing process 400 ends.

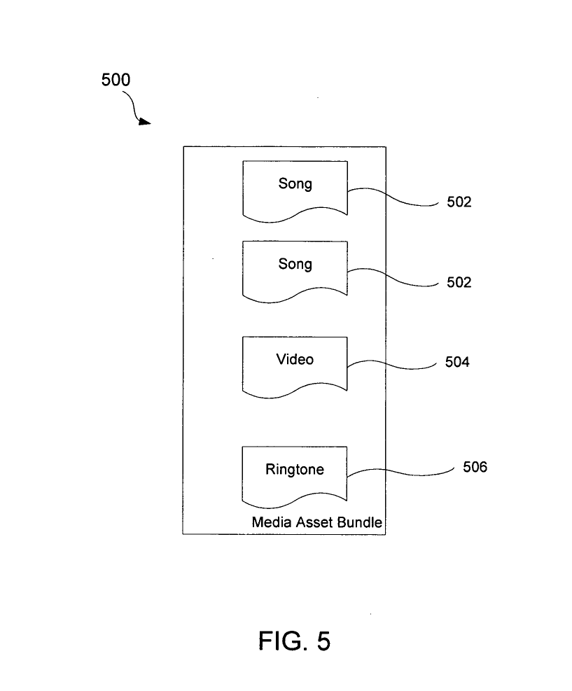

FIG. 5 is a block diagram of an exemplary media asset bundle 500 according to one embodiment of the invention. A media asset bundle is a collection of media assets grouped together for artistic or marketing reasons. One example of a media asset bundle is a collection of songs by one or more artists, such as a playlist or album. Another example is a collection of television episodes. Still another example is a collection of photographs. Media assets may be bundled as an incentive to a customer to buy the entire bundle at a discount, rather than buy each media asset separately. A media asset bundle can be any combination of media assets. Exemplary media asset bundle 500 contains song files 502, a music video file 504, and a ringtone 506.

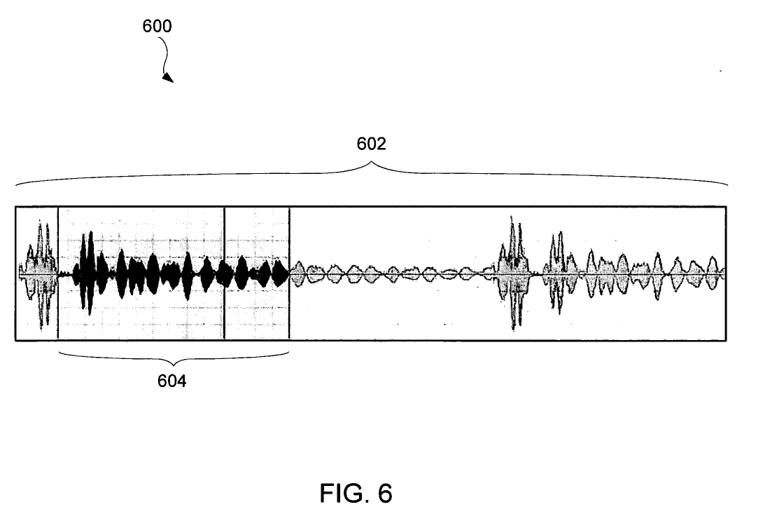

FIG. 6 is an illustration of an exemplary graphical waveform representation 600 of an audio file according to one embodiment of the invention. The exemplary graphical waveform representation 400 can be used as the waveform as presented 404 above in reference to FIG. 4.

The graphical waveform representation 600 has two segments. The first is a song segment 602. As described above in reference to FIG. 2, song segment 602 can be a complete song or a partial song. Also shown is a ringtone segment 604. The ringtone segment 604 can, for example, be a default ringtone segment as described above in reference to FIG. 4, above. Alternately, the ringtone segment 604 can be selected as described in reference to FIGS. 2 and 4, above. The one embodiment, the start point and end point for the ringtone segment 604 are alterable by he user to select different portions of the song segment 602 to serve as the ringtone segment 604.

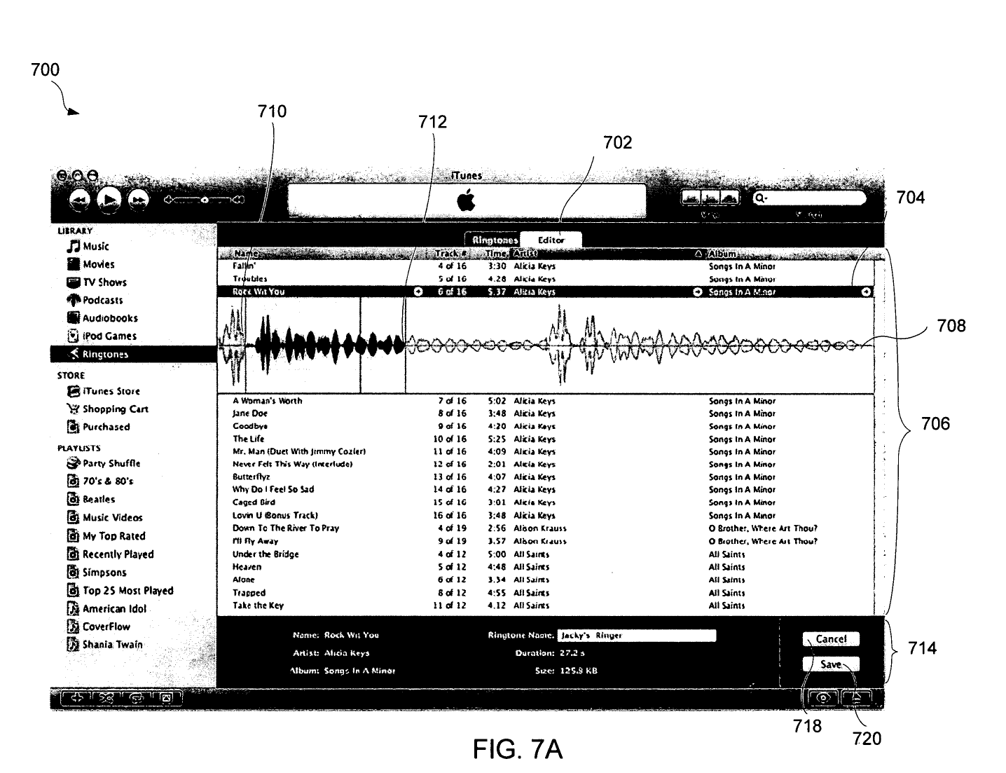

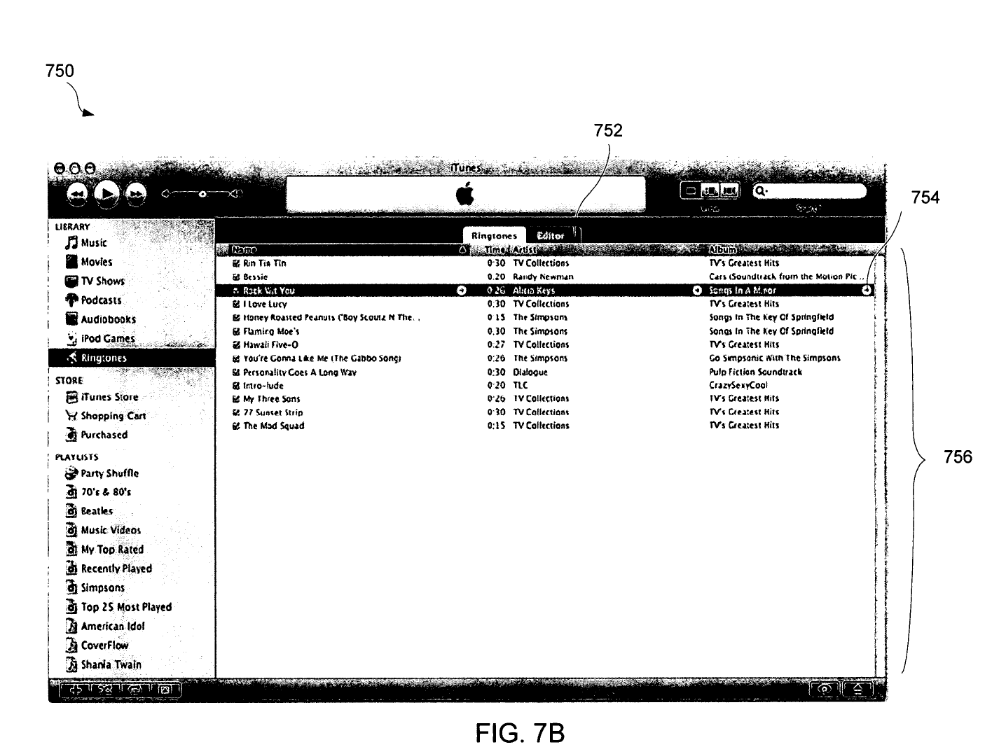

FIG. 7A is a screenshot of an exemplary iTunes® window 700 showing an interface for selecting, and creating ringtones according to one embodiment of the invention. In window 700, the Ringtone ‘Editor’ Tab 702 is selected. When the ringtone editor is active, selecting a music track 704 in the track listing 706 brings up a graphical waveform representation 708 of that music track 704. The information displayed in the track listing 706 gives information of partial or complete tracks that can be used to create ringtones. The graphical waveform representation 708 has a ringtone starting point 710 and a ringtone ending point 712 shown, which in turn define a ringtone 714. In this interface, the starting 710 and ending 712 points can be moved under user control. Below the track listing 706, is the ringtone information section 716, showing the information, including artist name, song name, album name, ringtone duration, ringtone size, and ringtone name. Finally, two interface controls, cancel button 718 and save button 720, allow the user to accept or cancel changes made to the ringtone 714.

FIG. 7B is a screenshot of an exemplary iTunes® window 750 showing an interface for browsing ringtones according to one embodiment of the invention. All elements of window 750 are essentially the same as those shown in reference to window 700 in FIG. 7A, with the exception that, in window 750, the ‘Ringtones’ tab 752 is selected. Ringtone information for those ringtones within a library are displayed I the ringtone list 756. The ringtone information for each ringtone can include name, time (duration), artist and album. In window 750, a ringtone 754 is selected from a ringtone list 756.

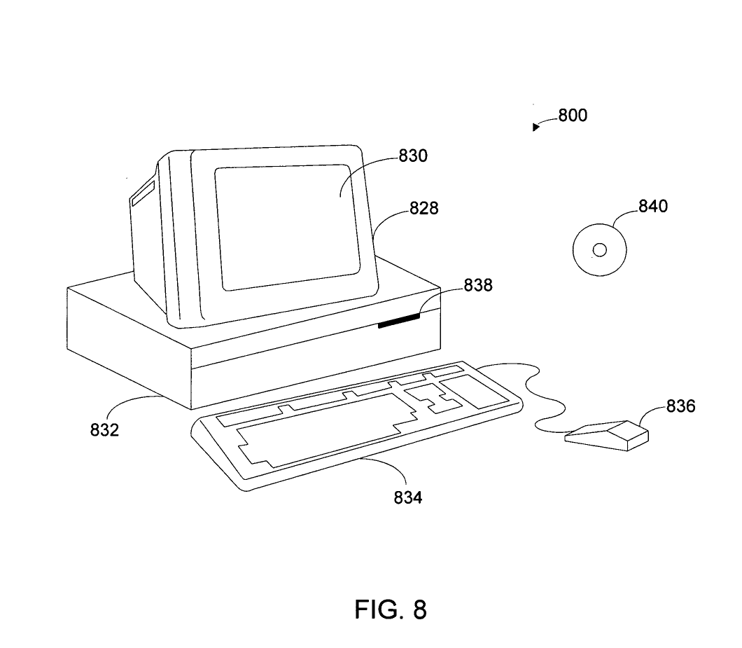

FIG. 8 shows an exemplary computer system 800 suitable for use as a client according to one embodiment of the invention. The computer system 800 includes a display monitor 828 having single or multi-screen displays 830 (or multiple displays), cabinet 832, keyboard 834, and mouse 836. Cabinet 832 houses a drive 838, such as a CD-ROM, or floppy drive, system memory and a hard drive (not shown) which may be utilized to store and retrieve software programs incorporating computer code that implements the present invention, data for use with the invention, and the like. Although CD-ROM 840 is shown as an exemplary computer readable storage medium, other computer readable storage media including CD-R, CD-RW, DVD, DVD-R, DVD-RW, floppy disk, tape, flash memory, system memory, and hard drive may be utilized. Additionally, a data signal embodied in a carrier wave (e.g., in a network including the Internet) may be the computer readable storage medium. In one implementation, an operating system for the computer system 800 is provided in the system memory, the hard drive, the CD-ROM 840 or other computer readable storage medium and serves to incorporate the computer code that implements the invention.

The advantages of the invention are numerous. Different embodiments or implementations may, but need not, yield one or more of the following advantages. One advantage of this invention is that users may browse, create and organize ringtones. Another advantage of the invention is that user can purchase ringtones that have or can be customized. Still another advantage is that artists can exert more control over the sale of their songs as cell phone ringtones.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for creating a ringtone, comprising:
(a) selecting a media asset;
(b) determining whether the rights to create a ringtone from the media asset has been obtained;
(c) creating the ringtone from the selected media asset; and
(d) transferring the ringtone to a telephone.

2. A computer-implemented method as recited in claim 1, wherein the when the determining (b) determines that the rights to create a ringtone from the media asset have not been obtained, the method further comprises obtaining the rights to create a ringtone.

3. A computer-implemented method as recited in claim 1, wherein the creating of the ringtone further comprises:
(e) purchasing the ringtone prior to the transferring (d).

4. A computer-implemented method as recited in claim 1, wherein the creating (c) of the ringtone comprises:
selecting a point in the selected media asset for use as a starting point for the ringtone; and
selecting a point in the selected media asset for use as an ending point for the ringtone.

5. A computer-implemented method as recited in claim 1, wherein the creating (c) of the ringtone comprises choosing a default ringtone that is available for the selected media asset.

6. A computer-implemented method as recited in claim 1, further comprising:
(e) previewing the created ringtone prior to the transferring (d).

7. A computer-implemented method as recited in claim 1, wherein the transferring (d) of the ringtone occurs using a synchronization process with a host computer.

8. A computer-implemented method as recited in claim 7, wherein the host computer is a personal computer.

9. A computer-implemented method as recited in claim 7, wherein the synchronization process occurs via a USB.

10. A computer-implemented method as recited in claim 7, wherein the synchronization process occurs via an IE-1394 connection.

11. A computer-implemented method as recited in claim 7, wherein the synchronization process occurs via an infrared port.

12. A computer-implemented method as recited in claim 7, wherein the synchronization process occurs via Bluetooth® connection.

13. A computer-implemented method as recited in claim 7, wherein the synchronization process occurs via a wireless connection.

14. A computer-implemented method as recited in claim 13, wherein the wireless connection is selected from the group consisting of: a cellular connection, a WiFi connection, and a WiMax connection.

15. A computer-implemented method as recited in claim 1, wherein the telephone is selected from the group consisting of a cellular telephone and a home telephone.

16. A computer-implemented method as recited in claim 1, wherein the creating (c) of the ringtone further encoding the ringtone with a Digital Rights Management (DRM) protection scheme.

17. A computer-implemented method as recited in claim 1, wherein the selected media asset is a DRM protected media asset.

18. A computer-implemented method as recited in claim 1, wherein the selected media asset is an unprotected media asset.

19. A computer-implemented method for purchasing a ringtone, comprising:
(a) browsing a group of media assets;
(b) selecting a media asset from the group of media assets;
(c) choosing a segment of the media asset to be used as a ringtone;
(d) previewing the ringtone;
(e) purchasing the ringtone; and
(f) transferring the ringtone to an electronic device.

20. A computer-implemented method as recited in claim 19, wherein the transferring (f) of the ringtone occurs using a synchronization process with a host computer.

21. A computer-implemented method as recited in claim 20, wherein the host computer is a personal computer.

22. A computer-implemented method as recited in claim 20, wherein the synchronization process occurs via a wired connection.

23. A computer-implemented method as recited in claim 20, wherein the synchronization process occurs via a wireless connection.

24. A computer-implemented method as recited in claim 19, wherein the electronic device is a mobile phone.

25. A computer-implemented method as recited in claim 19, wherein the choosing (c) of the segment of the media asset to be used as a ringtone is done by selecting a beginning end point and an end point on a graphical waveform representation of the media asset.

26. A computer-implemented method as recited in claim 19, wherein the purchased ringtone further is encoded with a Digital Rights Management (DRM) protection scheme.

27. A computer-implemented method as recited in claim 19, wherein the media asset is a DRM protected media asset.

28. A computer-implemented method as recited in claim 19, wherein the media asset is an unprotected media asset.

29. A computer-implemented method as recited in claim 19, wherein the purchased ringtone is encoded with a Digital Rights Management (DRM) protection scheme.

30. A computer readable medium including at least computer program code for creating a ringtone, said computer readable medium comprising:
computer program code for selecting a media asset;
computer program code for creating the ringtone from the selected media asset; and
computer program code for electronically transferring the ringtone to an electronic device.

31. A computer readable medium as recited in claim 30, wherein said computer program code for creating receives user selections regarding at least one of a selected start point in the selection asset for the start of the ringtone and a selected end point in the selected asset for the end of the ringtone.

32. A computer readable medium as recited in claim 30, wherein said computer readable medium further comprises:
computer program code for determining whether rights to create a ringtone from the media asset are present.

33. A computer readable medium as recited in claim 30, wherein said computer readable medium further comprises:
computer program code for obtaining rights to create a ringtone from the media asset.

34. A computer readable medium as recited in claim 30, wherein said computer readable medium further comprises:
computer program code for purchasing rights to at least create a ringtone from the media asset.

35. A computer readable medium as recited in claim 30, wherein the electronic device is a mobile phone.

36. A computer readable medium as recited in claim 30, wherein the electronic device is a telephone-enabled device.
